(19) United States
(12) Patent Application Publication
(10) Pub. No.: US 2025/0313702 A1
(43) Pub. Date: Oct. 9, 2025

(54) SEALANT COMPOSITIONS

(71) Applicant: Henkel AG & Co. KGaA, Duesseldorf (DE)

(72) Inventors: Frank D. Lesh, Livonia, MI (US); Andrew M. Dahl, Wixom, MI (US); Donald R. Vonk, Clinton Township, MI (US); Bashir M. Ahmed, Rochester, MI (US)

(21) Appl. No.: 19/239,084

(22) Filed: Jun. 16, 2025

Related U.S. Application Data
(63) Continuation of application No. PCT/US2023/077731, filed on Oct. 25, 2023.
(60) Provisional application No. 63/386,616, filed on Dec. 8, 2022.

(51) Int. Cl. C09D 5/08; C09D 1/04; C09D 7/45; C09D 7/63

(52) U.S. Cl. CPC C09D 5/086; C09D 1/04; C09D 7/45; C09D 7/63

(57) ABSTRACT

Sealant compositions for conferring unpainted corrosion resistance to a metal surface, such as an aluminum alloy, methods for conferring corrosion resistance by applying the sealant compositions, and metal surfaces, components, and articles that have been thereby rendered corrosion resistant, wherein the sealant compositions may be substantially free of chromium (VI), permanganate, heavy metals, or lanthanide rare-earth metals, and can provide performance similar to the military Class 1A specification by conferring protection against corrosion, whether painted or unpainted.

### TECHNICAL FIELD

The present disclosure pertains to compositions for protecting a metal surface from corrosion.

### BACKGROUND

The aerospace industry currently uses hexavalent chromium pretreatments under paint layers on metal components for required paint adhesion and corrosion protection. Chromate conversion coatings are highly soluble in water, easy to apply, robust, and inexpensive. In particular, chromate conversion coatings are highly effective because they provide strong barrier properties against water, oxygen, and chloride, in addition to providing “active” or “self-healing” corrosion inhibition. However, chromium (VI) is problematic due to safety and environmental concerns, and many chromium containing chemicals are anticipated to be more heavily regulated and possibly banned in some locations.

Class 1A qualification to the military specification (MIL-DTL-81706B) requires “bare” (unpainted) corrosion resistance (exhibiting ≤15 pits over 5 panels; ≤5 pits/panel, each panel measuring 10 inch×3 inch×0.032 inches) on AA2024-T3 and AA7075-T6 alloys after 336 hours of ASTM B117 neutral salt spray testing. Class 1A qualification to MIL-DTL-81706B also requires painted wet tape adhesion testing performance of no loss of adhesion along scribes after 24 hours of boiling water soak and tape adhesion test. Painted wet adhesion was evaluated in accordance with the MIL-DTL-81706B specification referencing FED-STD-141D (Method 6301.3).

After decades of research, still no Cr-free replacement exists for chromium pretreatments that meets the Class 1A requirements of the Class 1A military specification. One technical challenge is to match the self-healing corrosion mechanism of Cr (VI) as closely as possible with a different chemistry free of Cr (VI) preferably free of chromium. Another technical challenge presented by the AA2024-T3 and AA7075-T6 aluminum alloys, which are used in the aerospace industry, is their high copper content used to increase the strength-to-weight ratio (these are mainly used on the fuselage and wings, which are under tension). The intermetallic copper acts as cathodic corrosion sites where pitting is initiated. There are no other metal pretreatment applications where bare metal is evaluated under such aggressive conditions; most other applications rely on an added layer of paint and paint adhesion for corrosion protection.

M. W. Kendig et al., Corrosion 2003, 59, 379-400; NACE International describes general trends and examples of chemistries that have been investigated as alternatives to chromate-based coatings. Examples of alternative chemistries/approaches that have been investigated and found unsuccessful include hypervalent transition metal oxoanions, refractive metal oxide precursors, rare earth elements, sol-gel chemistry, alkaline earth chemistries and hydrotalcite coatings, corrosion inhibiting pigments, and conducting polymer films (id.). As noted by the authors, “a coating chemistry and technology for replacing chromate conversion still does not exist. Approaches to successfully replace chromate from current coating and inhibitor formulations will have to rely on the use of several chemistries engineered to play in concert the role of the unique Cr (VI) oxoanions.” No further guidance is provided on identifying or combining the several chemistries.

PPG announced in February 2019 that one of its aerospace conversion coatings has been qualified to U.S. Military Specification MIL-C-81706, Type II, Class 3, Form IV, Method A (compositions containing no hexavalent chromium; for protection against corrosion where low electrical resistance is required; premixed liquid, thixotropic; spray). Qualification for Class 3 testing is on AA6061-T6 at 168 hours of bare salt spray testing. Qualification for Class 1A testing is on AA2024-T3 and AA7075-T6 at 336 hours of bare salt spray testing; in comparison to the Class 3 qualification, this is twice the number of hours of bare salt spray testing on much more challenging high copper-containing aluminum alloys. Currently, there is no available commercial source of a chromium-free product that passes the Class 1A qualification to the military specification (maximum protection against corrosion, painted or unpainted).

### SUMMARY

Disclosed herein are sealant compositions for conferring corrosion resistance on a metal surface, the sealant compositions comprising lithium polysilicate, a corrosion inhibitor, an adhesion promoter, and water. Desirably, the sealant composition contains little or no added chromium other than trace amounts from other raw materials or dissolved from the substrate, preferably the sealant contains less than 20 ppm chromium (VI).

Also disclosed are methods for protecting a metal surface comprising contacting a conversion-coated metal surface with a sealant composition according to the present disclosure.

The present disclosure also provides metal components comprising a surface that has been contacted with a sealant composition according to the present disclosure. Also provided are articles respectively comprising a metal component that has been contacted with a sealant composition according to the present disclosure.

Also provided are articles of manufacture comprising a metal surface having deposited thereon a conversion coating and a sealant layer, dried in place on the conversion coating, which comprises lithium, silicon, carbon, and oxygen.

The present disclosure also provides articles of manufacture comprising a metal surface having deposited thereon a sealant layer in which lithium is distributed in an amount of about 2-7 mg/m², as measured by glow discharge optical emission spectrometry (GD-OES).
In one aspect of the disclosure (Aspect 1), a sealant composition for conferring corrosion resistance on a metal surface is provided comprising: lithium polysilicate; a corrosion inhibitor; and, an adhesion promoter; and water; wherein the sealant composition contains substantially no chromium (VI). Further Aspects include:
Aspect 2: The sealant composition according to Aspect 1, wherein the lithium polysilicate is present in an amount of about 1-3 wt. %, based on the total weight of the composition.
Aspect 3: The sealant composition according to Aspect 2, wherein the lithium polysilicate is present in an amount of about 1.45-2.25 wt. %, based on the total weight of the composition.
Aspect 4: The sealant composition according to any one of the preceding Aspects, wherein the corrosion inhibitor comprises one or more of a quinoline, an organic phosphate ester, an azolic functional molecule, or any combination thereof.
Aspect 5: The sealant composition according to any one of the preceding Aspects, wherein the corrosion inhibitor comprises 8-hydroxyquinoline, an organic phosphate ester, salicylaldoxime, quinaldic acid, 1H-benzotriazole, tolyltriazole, methyl-1-H-benzotriazole, 2-mercaptobenzothiazole, 2-mercaptobenzoxazole, 5-amino-1,3,4-thiadiazole-2-thiol, L-cysteine, 5-aminotetrazole, 2-aminothiazole, or any combination thereof.
Aspect 6: The sealant composition according to any one of the preceding Aspects, wherein the corrosion inhibitor comprises 8-hydroxyquinoline.
Aspect 7: The sealant composition according to any preceding Aspect, wherein the corrosion inhibitor comprises a C8-C16-alkyl polyglycol ether.
Aspect 8: The sealant composition according any one of the preceding Aspects, wherein the corrosion inhibitor comprises a lauryl polyglycol ether based phosphoric acid ester.
Aspect 9: The sealant composition according to any one of the preceding Aspects, wherein the corrosion inhibitor is present in an amount of about 0.005 wt. %, based on the total weight of the composition, up to the solubility limit of the corrosion inhibitor in the sealant composition.
Aspect 10: The sealant composition according any one of the preceding Aspects, wherein the composition is alkaline.
Aspect 11: The sealant composition according to any one of the preceding Aspects, wherein the adhesion promoter comprises an organofunctional alkoxysilane compound.
Aspect 12: The sealant composition according to any one of the preceding Aspects, wherein the adhesion promoter includes alkoxy functional groups.
Aspect 13: The sealant composition according to any one of the preceding Aspects, wherein the adhesion promoter includes organofunctional groups comprising epoxy, epoxyalkyl, epoxyalkoxy, amino, aminoalkyl, or aminoalkylamino groups, or any combination thereof.
Aspect 14: The sealant composition according to any one of the preceding Aspects, wherein the adhesion promoter comprises 3-glycidyloxypropyltrimethoxysilane, N-2-aminoethyl-3-aminopropyltrimethoxysilane, or both.
Aspect 15: The sealant composition according to any one of the preceding Aspects, wherein the adhesion promotor is present in an amount of about 0.5-5 wt. %, based on the total weight of the composition.
Aspect 16: The sealant composition according to any one of the preceding Aspects, further comprising a surfactant.
Aspect 17: The sealant composition according to any one of the preceding Aspects, wherein the sealant composition does not include any source of a metal, other than the lithium polysilicate.
Aspect 18: A method for protecting a metal surface against corrosion comprising contacting a conversion coated metal surface with a sealant composition according to any one of Aspects 1-17.
Aspect 19: The method according to Aspect 18, wherein the conversion coated metal surface is immersed within the sealant composition.
Aspect 20: The method according to Aspect 18 or Aspect 19, wherein the conversion coated metal surface is contacted with the sealant composition under ambient temperature conditions.
Aspect 21: The method according to any one of Aspects 18-20, wherein the metal surface comprises aluminum or an aluminum alloy.
Aspect 22: The method according to any one of Aspects 18-21, further comprising contacting the metal surface with a conversion coating composition prior to the step of contacting the metal surface with the sealant composition, wherein the conversion coating composition does not contain any source of chromium.
Aspect 23: The method according to any one of Aspects 18-22, wherein the conversion coating composition comprises a Group IVB metal.
Aspect 24: The method according to any one of Aspects 18-23, wherein the conversion coated metal surface comprises oxides of the Group IVB metal.
Aspect 25: The method according to any one of Aspects 18 to 24, wherein the conversion coating comprises Zr, Ti, or both.
Aspect 26: The method according to any one of Aspects 18-25, further comprising the step of deoxidizing the metal surface prior to the step of contacting the metal surface with the sealant composition.
Aspect 27: The method according to Aspect 26, wherein the step of deoxidizing the metal surface is prior to contacting the metal surface with a conversion coating composition.
Aspect 28: The method according to any one of Aspects 18-27, further comprising the step of degreasing the metal surface prior to the step of contacting the metal surface with the sealant composition.
Aspect 29: The method according to Aspect 28, wherein the step of degreasing the metal surface is prior to deoxidizing the metal surface, and is prior to contacting the metal surface with a conversion coating composition.
Aspect 30: A metal component comprising a surface that has been contacted with a sealant composition according to any one of Aspects 1-17.
Aspect 31: The metal component according to Aspect 30, wherein the surface comprises aluminum or an aluminum alloy.
Aspect 32: An article comprising a metal component according to Aspect 30 or Aspect 31.
Aspect 33: An article of manufacture comprising: a metal surface having deposited thereon a conversion coating comprising a Group IVB metal, and a sealant layer dried in place on the conversion coating comprising Li, Si, C and O.
Aspect 34: An article of manufacture comprising a metal surface having deposited thereon a sealant layer in which lithium is distributed in an amount of about 2-7 mg/m², as measured by glow discharge optical emission spectrometry (GD-OES).

### BRIEF DESCRIPTION OF THE DRAWINGS

FIG. 1A depicts a flow diagram of conventional (chromium-containing) conversion process (comparative) and FIG. 1B provides a flow diagram of a conversion process that uses a sealant composition according to the present disclosure.

FIG. 2 provides a GD-OES spectrum for a cleaned and deoxidized and uncoated AA2024 aluminum alloy.

FIG. 3 provides a GD-OES spectrum for the AA2024 aluminum alloy of FIG. 2 that has been processed through a non-chromium conversion coating bath.

FIG. 4 provides a GD-OES spectrum for the AA2024 aluminum alloy of FIG. 3 that has been immersed in an exemplary sealant composition.

FIG. 5 provides a GD-OES spectrum for the AA2024 aluminum alloy of FIG. 3 that has been immersed in a further exemplary sealant composition

FIG. 6 provides a GD-OES spectrum for the AA2024 aluminum alloy of FIG. 3 that has been immersed in a further exemplary sealant composition.

FIG. 7 provides a GD-OES spectrum for the AA2024 aluminum alloy of FIG. 3 that has been immersed in a further exemplary sealant composition.

### DETAILED DESCRIPTION OF ILLUSTRATIVE EMBODIMENTS

The presently disclosed inventive subject matter may be understood more readily by reference to the following detailed description taken in connection with the accompanying figures and examples, which form a part of this disclosure. It is to be understood that these inventions are not limited to the specific components, methods, or parameters described and/or shown herein, and that the terminology used herein is for the purpose of describing particular embodiments by way of example only and is not intended to be limiting of the claimed inventions.

The entire disclosures of each patent, patent application, and publication cited or described in this document are hereby incorporated herein by reference.

As employed above and throughout the disclosure, the following terms and abbreviations, unless otherwise indicated, shall be understood to have the following meanings.

In the present disclosure the singular forms “a,” “an,” and “the” include the plural reference, and reference to a particular numerical value includes at least that particular value, unless the context clearly indicates otherwise. Thus, for example, a reference to “a corrosion inhibitor” is a reference to one or more of such corrosion inhibitors and equivalents thereof known to those skilled in the art, and so forth. Furthermore, when indicating that a certain element “may be” X, Y, or Z, it is not intended by such usage to exclude in all instances other choices for the element.

When values are expressed as approximations, by use of the antecedent “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. In some embodiments, “about X” (where X is a numerical value) refers to +10% of the recited value, inclusive. For example, the phrase “about 8” can refer to a value of 7.2 to 8.8, inclusive. This value may include “exactly 8”. Where present, all ranges are inclusive and combinable. For example, when a range of “1 to 5” is recited, the recited range should be construed as optionally including ranges “1 to 4”, “1 to 3”, “1-2”, “1-2 & 4-5”, “1-3 & 5”, and the like. In addition, when a list of alternatives is positively provided, such a listing can also include embodiments where any of the alternatives may be excluded. For example, when a range of “1 to 5” is described, such a description can support situations whereby any of 1, 2, 3, 4, or 5 are excluded; thus, a recitation of “1 to 5” may support “1 and 3-5, but not 2”, or simply “wherein 2 is not included.”

As described above, the aerospace industry and other industries using metal parts such as aerospace aluminum alloys do not possess metal pretreatment applications that meet the Class 1A requirements of the military specification while representing an alternative to the widely-used chromium pretreatments. The present inventors have surprisingly discovered sealant compositions for the pretreatment of metal surfaces, including those of aerospace aluminum alloys, which are water-based, alkaline, substantially free of heavy, permanganate, and lanthanide metals, and may be operated at ambient temperatures with short immersion times. Whereas known non-chromium conversion coatings alone demonstrate virtually no unpainted corrosion resistance (>100 pits; major corrosion), application of the presently discovered sealant compositions substantially enhances corrosion protection without compromising paint adhesion performance. For example, as disclosed more fully herein, when the present sealing compositions are used on aluminum surfaces pretreated with Cr-free conversion coating, no pitting or white corrosion products were observed after 168 hours (1 week) of neutral salt spray testing on AA2024-T3 aluminum alloy, after 336 hours (2 weeks) of neutral salt spray testing on AA6061-T6 aluminum alloy, and after 240 hours (10 days) of neutral salt spray testing on AA7075-T6 aluminum alloy. Furthermore, following application of the present compositions to the above described conversion coated metal surface, panels were subsequently painted, and adhesion tested which resulted in no loss of paint adhesion observed along the scribes after 24 hours of boiling water soak and tape adhesion testing, even when using a non-Cr paint primer.

Accordingly, in one embodiment, disclosed herein are sealant compositions for conferring corrosion resistance on a metal surface comprising lithium polysilicate, a corrosion inhibitor, an adhesion promoter, and water, wherein the sealant composition contains less than 20 ppm chromium (VI).

The lithium polysilicate may be provided in an amount of about 1-3 wt. %, based on the total weight of the composition. Lithium polysilicate is commercially available as a 20% (w/w) dilution in water, and the present invention includes compositions which may use this commercially available source. Accordingly, the amount of lithium polysilicate is expressed herein with respect to the commercially available 20% (w/w) dilution in water. In certain embodiments, the lithium polysilicate is present in the composition in an amount of about 1.2-2.75 wt. %, about 1.3-2.5 wt. %, about 1.4-2.4 wt. %, or about 1.45-2.25 wt. %. For example, the lithium polysilicate may present in the composition in an amount of about 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3 wt. %, based on the total weight of the composition.

Corrosion inhibitors that may be in the present compositions may include nitrogen-containing corrosion inhibitors. The corrosion inhibitor may be, for example, a quinoline, an organic phosphate ester, an azolic functional molecule, or any combination thereof. Azolic functional molecules can include, for example, diazole, triazole, tetrazole, or the like, and such molecules may optionally further comprise oxygen, sulfur, or both. The organic phosphate ester may be a linear, branched, saturated or unsaturated fatty alcohol phosphate ester. For example, the organic phosphate ester may be a C4-C26-alkyl polyglycol ether, including a C4-C26-, C8-C16-, or C10-C14-alkyl polyglycol ether, such as a linear or branched polyglycol ether, including a polyalkoxy phosphoric acid ester, and preferably a lauryl polyglycol ether based phosphoric acid ester. Further examples of corrosion inhibitors that may be used in the present compositions include 8-hydroxyquinoline, an organic phosphate ester, a fatty acid alkoxylated phosphoric acid ester, a lauryl polyglycol ether based phosphoric acid ester, salicylaldoxime, quinaldic acid, 1H-benzotriazole, tolyltriazole, methyl-1-H-benzotriazole, 2-mercaptobenzothiazole, 2-mercaptobenzoxazole, 5-amino-1,3,4-thiadiazole-2-thiol, L-cysteine, 5-aminotetrazole, 2-aminothiazole, or any combination thereof.

The corrosion inhibitor (which can be two or more corrosion inhibitors) may be present in the sealant composition in an amount of about 0.005 wt. %, based on the total weight of the composition, up to the solubility limit of the corrosion inhibitor. In certain examples, the corrosion inhibitor is present in an amount of about 0.005-0.2 wt. %, such as in an amount of about 0.005, 0.01, 0.015, 0.02, 0.03, 0.04, 0.05, 0.06, 0.07, 0.08, 0.09, 0.1, 0.125, 0.15, 0.175, or 0.2 wt. %, based on the total weight of the composition.

The adhesion promotor of the present compositions may be, for example, an organofunctional alkoxysilane compound. The alkoxy functional groups in such compounds may be methoxy groups, ethoxy groups, propoxy groups, or any combination thereof. The organofunctional groups in the adhesion promotor compounds may include, for example, epoxy, epoxyalkyl, epoxyalkoxy, amino, aminoalkyl, or aminoalkylamino groups, or any combination thereof.

Exemplary epoxysilanes include, but are not limited to, glycidoxymethyltrimethoxysilane, 3-glycidoxypropyltrihydroxysilane, 3-glycidoxypropyl-dimethylhydroxysilane, 3-glycidoxypropyltrimethoxysilane, 3-glycidoxypropyl triethoxysilane, 3-glycidoxypropyldimethoxymethylsilane, 3-glycidoxypropyldimethyl-methoxysilane, 3-glycidoxypropyltributoxysilane, 1,3-bis(glycidoxypropyl)tetramethyldisiloxane, 1,3-bis (glycidoxypropyl)tetramethoxydisiloxane, 1,3-bis (glycidoxypropyl)-1,3-dimethyl-1,3-dimethoxydisiloxane, 2,3-epoxypropyl-trimethoxysilane, 3,4-epoxybutyl-trimethoxysilane, 6,7-epoxyheptyl-trimethoxysilane, 9,10-epoxydecyltrimethoxysilane, 1,3-bis(2,3-epoxypropyl)tetramethoxydisiloxane, 1,3-bis(6,7-epoxyheptyl)tetra-methoxydisiloxane, 2-(3,4-epoxycyclohexyl)ethyltrimethoxysilane, and the like.

Any suitable aminosilane can be used. In some embodiments, the aminosilane is a multi-functional aminosilane such as silanes having two or more amino groups per molecule. While any suitable aminosilane can be used, examples of suitable aminosilanes include, but are not limited to, the monoamine functional 3-aminopropyltriethoxysilane, and 3-aminopropyl trimethoxysilane, the diamine functional (containing both secondary and tertiary amine functionally) 2-aminoethyl-3-aminopropyltrimethoxysilane (also referred to as “DAMO”), and the secondary amine functional n-butylaminopropyltrimethoxysilane, and n-ethylaminoisobutylrtimethoxysilane.

In some embodiments, the adhesion promoter comprises 3-glycidyloxypropyltrimethoxysilane, N-2-aminoethyl-3-aminopropyltrimethoxysilane, or both.

The amount of adhesion promotor in the present sealant compositions may be about 0.5-5 wt. %, based on the total weight of the composition. For example, the amount of adhesion promoter may be about 0.6-4, 0.65-4, 0.7-4, or 0.7-0.35 wt. %, such as about 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or 5 wt. %, based on the total weight of the composition.

The sealant compositions may further include a surfactant. The surfactant may be ionic or anionic. The surfactant may be, for example, an alkoxylated alcohol surfactant (such as a secondary alcohol ethoxylate that may be ionic or preferably anionic) or a sulfosuccinate anionic surfactant. Exemplary surfactants include Tergitol 15-S-7 (a secondary alcohol ethoxylate) nonionic surfactant. Other compatible surfactants include, but are not limited to, Aerosol OT-70PG or Aerosol WA-300 (diester sulfosuccinate) anionic surfactants, and ECOSURF EH-9 (secondary alcohol ethoxylate) nonionic surfactant.

The sealant compositions are preferably alkaline. For example, the compositions may have a pH in a range of 8-14, such as 9-12, or 9.5-11.

The sealant compositions according to the present disclosure are free of or substantially free of chromium (VI), and can therefore meet the requirements of REACH regulations, while simultaneously improving corrosion performance over non-chrome conversion coating alone, and approaching performance similar to the military Class 1A specification by conferring surprising protection against corrosion, whether painted or unpainted. As used herein, “substantially free of chromium (VI)” when referring to the present compositions can mean that the compositions contain less than 20 ppm of chromium (VI). In some embodiments, the compositions contain less than 20, 19, 18, 17, 16, 15, 14, 13, 12, 11, 10, 9, 8, 7, 6, 5, 4, 3, 2, or 1 ppm of chromium (VI). In certain embodiments, the compositions do not contain any chromium (VI).

The sealant compositions according to the present disclosure may also be substantially free of chromium (III). As used herein, “substantially free of chromium (III)” when referring to the present compositions can mean that the compositions contain less than 20 ppm of chromium (III). In some embodiments, the compositions contain less than 20, 19, 18, 17, 16, 15, 14, 13, 12, 11, 10, 9, 8, 7, 6, 5, 4, 3, 2, or 1 ppm of chromium (III). In certain embodiments, the compositions do not contain any chromium (III).

Preferably, the present sealant compositions do not contribute chromium (VI) or (III) to the conversion coating system in which they are used (beyond that which they would contribute while qualifying as substantially free of chromium (VI) and (III) as specified above), and the only chromium (VI) or chromium (III) that are present in the conversion coating system in which the present compositions are applied represent trace amounts deriving from trace elements in the raw materials, treated substrates, or water that are used. For example, aluminum alloys can themselves contain chromium (VI): alloy AA2024-T3 contains 0.01% (100 ppm) Cr, alloy AA6061-T6 contains 0.18% Cr (1800 ppm), and alloy AA7075-T6 contains 0.19% Cr (1900 ppm). Current federal drinking water standard for total chromium, including chromium (VI) and chromium (III), is 0.1 mg/L (0.1 ppm/100 ppb/0.00001% Cr). By comparison to the present compositions, the working bath of BONDERITE M-CR T 5900 contains 0.053% Cr (530 mg/L or 530 ppm) (see U.S. Pub. No. 2017/0009330, incorporated herein by reference).

In certain embodiments, the present sealant compositions do not contain any sources of permanganate, heavy metals, or rare earth metals. Preferably, the only metal source within the sealant compositions is the alkali metal of lithium that is introduced via the lithium polysilicate. As such, in some embodiments, the sealant compositions are substantially free of permanganate, heavy metals, or rare earth metals, by which it is intended to mean that the compositions contain less than 20 ppm of any of permanganate, heavy metals, or rare earth metals, respectively (i.e., less than 20 ppm of permanganate, less than 20 ppm of heavy metals, and less than 20 ppm of rare earth metals). In some embodiments, the compositions contain less than 20, 19, 18, 17, 16, 15, 14, 13, 12, 11, 10, 9, 8, 7, 6, 5, 4, 3, 2, or 1 ppm of permanganate, heavy metals, or rare earth metals, respectively. In certain embodiments, the compositions do not contain any permanganate. In certain embodiments, the compositions do not contain any heavy metals. In certain embodiments, the compositions do not contain any rare earth metals.

Also provided herein are methods for protecting a metal surface against corrosion, comprising contacting a conversion-coated metal surface with a sealant composition according to any of the embodiments disclosed supra. The metal surface may be the surface of any metal piece, component, or part requiring protection against corrosion, including, for example, steel, aluminum and alloys thereof, zinc and alloys thereof, as well as metals coated with a layer of zinc, aluminum and alloys thereof, as well as Galvalume®, a mixture comprising aluminum, zinc and silicone. In preferred embodiments, the metal surface is the surface of an aluminum alloy. Aluminum alloys that are commonly used in aerospace applications include AA2024-T3, AA6061-T6, and AA7075-T6, any of which may be used pursuant to the present methods. The metal surface is conversion coated according to a conventional process, but is preferably conversion coated using a chromium free process. For example, the conversion coating process may comprise contacting the metal surface with a composition comprising Group IVB metal, thereby generating a conversion coated metal surface that comprises oxides of the Group IVB metal. Exemplary Group IVB metal constituents of the conversion coating include Zr, Ti, or both.

The step of contacting the conversion coated metal surface with the sealant composition may be accomplished by any conventional means. Preferably, the conversion coated metal surface immersed within the sealant composition. An advantageous feature of the present methods is that the step of contacting the conversion coated metal surface with the sealant composition may take place under ambient temperature conditions. For example, the temperature at which the contacting step takes place may be about 67-78° F.

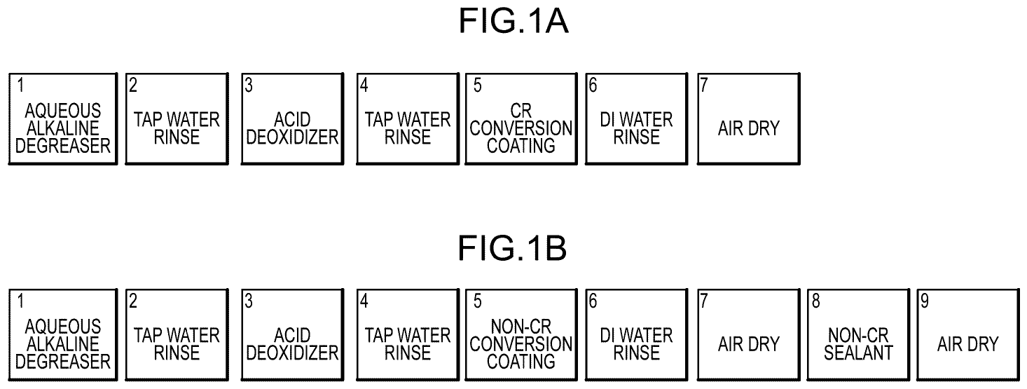

FIG. 1A provides a flow diagram of a conventional (chromium) conversion process for a metal surface. At step 5, a chromium conversion coating is applied to the metal. FIG. 1B provides a flow diagram of an exemplary conversion process according to the present disclosure, in which a non-chromium conversion coating is used at step 5, and an inventive sealant composition is applied at step 8.

The present methods may further include additional conventional steps associated with a conversion coating process. For example, the methods may further include a step of deoxidizing the metal surface prior to the step of contacting the metal surface with the sealant composition. The methods may include a step of degreasing the metal surface prior to the step of contacting the metal surface with the sealant composition. The step of degreasing the metal surface is preferably prior to deoxidizing the metal surface, and prior to contacting the metal surface with a conversion coating composition.

An exemplary process according to the present disclosure for conferring corrosion resistance on a metal component may be carried out using Steps 1-9 as provided below:
Step 1 (Cleaning Bath): Aqueous alkaline degreasing with BONDERITE® C-AK 6849 at 20% (v/v) and 60° C. for 15 minutes.
Step 2 (Tap Water Rinse): Warm tap water rinse for 5 minutes.
Step 3 (Deoxidation Bath): Acidic deoxidizing with BONDERITE® C-IC 2310 at 15%+25% HNO₃ (v/v) and ambient temperature for 5 minutes (etch rate of clad panel=0.1−0.4 mils/surface/hour).
Step 4 (Tap Water Rinse): Ambient tap water rinse for 2 minutes.
Step 5 (Non-Cr Conversion Coating): BONDERITE® M-NT 1820 (without copper additive; 3%, v/v; pH=4.4-4.6; free fluoride=50 ppm) at ambient temperature for 10 minutes (with agitation by magnetic stirring at 300 rpm).
Step 6 (Deionized Water Rinse): Ambient deionized water rinse for 2 minutes.
Step 7 (Air Dry): Ambient air dry for 10 minutes.
Step 8 (Non-Cr Sealant): Sealant bath composition at ambient temperature for 2 minutes (with agitation).
Step 9 (Air dry): Ambient air dry.

Also provided herein are metal components respectively comprising a surface that has been contacted with a sealant composition according to any of the embodiments described above. The surface may be the surface of any metal piece, component, or part requiring protection against corrosion, including, including, for example, steel, aluminum and alloys thereof, zinc and alloys thereof, as well as metals coated with a layer of zinc, aluminum and alloys thereof, as well as Galvalume®, a mixture comprising aluminum, zinc and silicone. In preferred embodiments, the metal surface is the surface of an aluminum alloy. Aluminum alloys that are commonly used in aerospace applications include AA2024-T3, AA6061-T6, and AA7075-T6, any of which may be used pursuant to the present methods.

The present disclosure also provides articles that comprise a metal component comprising a surface that has been contacted with a sealant composition according to any of the embodiments described above. The metal component may be according to any of the embodiments described in the immediately preceding paragraph. An article according to the present disclosure may be, for example, an aircraft or a component thereof, such as a wing, fuselage, engine housing, propeller, tail, fin, aileron, door, antenna, strut, or the like.

Also provided herein are articles of manufacture comprising a metal surface having deposited thereon a conversion coating, for example, comprising a Group IVB metal, and a sealant layer that is dried in place on the conversion coating and comprises Li, Si, C, and O. Exemplary Group IVB metal constituents of the conversion coating include Zr, Ti, or both. In some embodiments, the conversion coating includes Zr and oxygen. The sealant layer is preferably substantially free of chromium (VI), substantially free of chromium (III), or both. The metal surface may be the surface of any metal piece, component, or part requiring protection against corrosion, including, for example, steel, aluminum and alloys thereof, zinc and alloys thereof, and substrates having a coating of aluminum or zinc, and alloys thereof, e.g., Galvalume®. In preferred embodiments, the metal surface is the surface of an aluminum alloy. Aluminum alloys that are commonly used in aerospace applications include AA2024-T3, AA6061-T6, and AA7075-T6, any of which may be included in the presently disclosed articles.

In a further embodiment, provided are articles of manufacture comprising a metal surface having deposited thereon a sealant layer in which lithium is distributed in an amount of about 2-7 mg/m², as measured by glow discharge optical emission spectrometry (GD-OES). For example, the lithium may be distributed within the sealant layer in an amount of about 2, 2.5, 3, 3.5, 4, 4.5, 5, 5.5, 6, 6.5, or 7 mg/m², as measured by GD-OES. As described supra, the presently disclosed sealant compositions comprise lithium polysilicate, and the sealant layer that is produced by applying an inventive sealant composition to a metal surface may thereby contain lithium in the above-specified concentration.

### EXAMPLES

The present invention is further defined in the following Examples. It should be understood that these examples, while indicating preferred embodiments of the invention, are given by way of illustration only, and should not be construed as limiting the appended claims. From the above discussion and these examples, one skilled in the art can ascertain the essential characteristics of this invention, and without departing from the spirit and scope thereof, can make various changes and modifications of the invention to adapt it to various usages and conditions.

### Example 1—Tables of Exemplary Sealant Compositions and Conversion Coating Compositions

Table 1, below, provides ranges for components and conditions for exemplary sealant compositions according to the present disclosure.

TABLE 1

| | | Narrower |
|---|---|---|
| Parameter | Range | Range |
| lithium polysilicate (20 wt. % dilution) | 1-3% | 1.45-2.25% |
| 3-glycidyloxypropyltrimethoxysilane | 0.3-2% | 0.35-1.75% |
| N-2-aminoethyl-3- | 0.3-2% | 0.35-1.75% |
| aminopropyltrimethoxysilane | | |
| 8-hydroxyquinoline | 0.005-0.10% | 0.015-0.050% |
| lauryl polyglycol ether based | 0.005-0.20% | 0.010-0.150% |
| phosphoric acid ester | | |
| pH | 9.8-11 | 10-10.8 |

Table 2, below, provides ranges for components and conditions for exemplary conversion coating compositions that may be used for preparing a metal surface for treatment with the inventive sealant compositions.

TABLE 2

| | | |
|---|---|---|
| Parameter | Range | Narrower Range |

| | | | | |
|---|---|---|---|---|
| Zirconium | 50-750 | ppm | 100-200 | ppm |
| Nitrate | >3500 | ppm | 4000-8000 | ppm |

| | | |
|---|---|---|
| pH | 3.6-4.8 | 3.8-4.6 |

| | | | | |
|---|---|---|---|---|
| Free fluoride | 10-80 | ppm | 15-75 | ppm |

### Example 2—Sealant Composition and Application and Testing Thereof

To prepare a 700 g sealant immersion bath, 10.41 g (1.49%) of lithium polysilicate, 20% was stirred into 684.14 g of deionized water. To this solution was added 2.63 g (0.375%) of Dynasylan® GLYMO (3-Glycidyloxypropyltrimethoxysilane) obtained from Evonik. This solution was then stirred for a minimum of 30 minutes to ensure complete dissolution of the Dynasylan® GLYMO. Next, 2.63 g (0.375%) of Dynasylan® DAMO (N-2-Aminoethyl-3-aminopropyltrimethoxysilane) received from Evonik was added and the solution was stirred for 10 minutes. To this solution was added 0.19 g (0.027%) of 8-hydroxyquinoline and the solution was stirred for 1 hour to ensure complete dissolution of the 8-hydroxyquinoline (pH=10.16). Table 3 below provides a summary of the components of the sealant composition.

TABLE 3

| Component | Amount (g) | |
|---|---|---|
| Deionized water | 684.14 | g |
| Lithium polysilicate, 20% | 10.41 | g |
| Dynasylan ® GLYMO | 2.63 | g |
| Dynasylan ® DAMO | 2.63 | g |
| 8-hydroxyquinoline | 0.19 | g |

A Q-Lab AA2024-T3 aluminum panel (3″×10″×0.032″) was immersed into an aqueous alkaline degreaser bath (BONDERITE® C-AK 6849 at 20% v/v and 60° C.) for 15 minutes with constant agitation. The panel was then immersed into a warm tap water rinse tank for 5 minutes, then immersed into an acidic deoxidizing bath (BONDERITE® C-IC 2310 at 15% v/v+25% HNO₃ v/v and ambient temperature) for 5 minutes (etch rate of clad panel=0.1-0.4 mils/surface/hour). After deoxidation, the panel was immersed into an ambient tap water rinse tank for 2 minutes before being immersed into the “Non-Cr Conversion Coating” containing BONDERITE® M-NT 1820 (without copper additive; 3% (v/v); pH=4.2-4.4; free fluoride=50 ppm) at ambient temperature for 10 minutes with agitation by magnetic stirring at 300 rpm. Following conversion coating, the panel was immersed into an ambient deionized water rinse tank for 2 minutes and then air dried at ambient temperature for 10 minutes. Next, the panel was immersed in the sealant bath described above at ambient temperature for 2 minutes with slight agitation and then air dried at ambient temperature before performance evaluation.

The corrosion performance of processed substrate was evaluated after 7 days (168 hours) of neutral salt spray testing (ASTM B117) according to the MIL-DTL-81706B specification. Painted wet adhesion was evaluated in accordance with the MIL-DTL-81706B specification referencing FED-STD-141D (Method 6301.3) for test parameters. Panels were painted with a chromate-based paint primer (MIL-PRF-23377K, Type 1, Class C2; 23377F12-GL). Table 4, below, provides the results of the corrosion performance assessment. Test results from a sample that was not sealed is provided in Table 5.

TABLE 4

| | Corrosion Rating | Adhesion Rating |
|---|---|---|
| Sample | on AA2024 (168 hours NSS) | on AA2024 |
| 1 | 1 pit; little-to-no white | Negligible (little-to- |
| | corrosion products | no) paint pick-off |
| 2 | No pits; no white | Negligible (little-to- |
| | corrosion products | no) paint pick-off |
| 3 | 2 pits; light amount of white | Passing |
| | corrosion products | (no paint pick-off) |

TABLE 5

| | Corrosion Rating | |
|---|---|---|
| | on AA2024 | Adhesion Rating |
| Comparative Example 1 | (168 hours NSS) | on AA2024 |
| Conversion coating only | >100 pits; major | Passing (no paint |
| (BONDERITE ® M-NT 1820) | corrosion | pick-off) |

### Example 3—Sealant Composition and Application and Testing Thereof

To prepare a 700 g sealant immersion bath, 10.41 g (1.49%) of lithium polysilicate, 20% was stirred into 668.40 g of deionized water. To this solution was added 10.50 g (1.5%) of Dynasylan® GLYMO (3-Glycidyloxypropyltrimethoxysilane) obtained from Evonik. This solution was then stirred for a minimum of 30 minutes to ensure complete dissolution of the Dynasylan® GLYMO. Next, 10.50 g (1.5%) of Dynasylan® DAMO (N-2-Aminoethyl-3-aminopropyltrimethoxysilane) received from Evonik was added and the solution was stirred for 10 minutes. To this solution was added 0.19 g (0.027%) of 8-hydroxyquinoline and the solution was stirred for 1 hour to ensure complete dissolution of the 8-hydroxyquinoline (pH=10.24). Table 6 below provides a summary of the components of the sealant composition.

TABLE 6

| Component | Amount (g) | |
|---|---|---|
| Deionized water | 668.40 | g |
| Lithium polysilicate, 20% | 10.41 | g |
| Dynasylan ® GLYMO | 10.50 | g |
| Dynasylan ® DAMO | 10.50 | g |
| 8-hydroxyquinoline | 0.19 | g |

A Q-Lab AA2024-T3, AA6061-T6, and AA7075-T6 aluminum panels (3″×10″×0.032″) were immersed into an aqueous alkaline degreaser bath (BONDERITE® C-AK 6849 at 20% (v/v) and 60° C.) for 15 minutes with constant agitation. The panels were then immersed into a warm tap water rinse tank for 5 minutes, then immersed into an acidic deoxidizing bath (BONDERITE® C-IC 2310 at 15% (v/v)+25% HNO₃ (v/v) and ambient temperature) for 5 minutes (etch rate of clad panel=0.1-0.4 mils/surface/hour). After deoxidation, the panels were immersed into an ambient tap water rinse tank for 2 minutes before being immersed into the “Non-Cr Conversion Coating” containing BONDERITE® M-NT 1820 (without copper additive; 3% (v/v); pH=4.2-4.4; free fluoride=50 ppm) at ambient temperature for 10 minutes with agitation by magnetic stirring at 300 rpm. Following conversion coating, the panels were immersed into an ambient temperature deionized water rinse tank for 2 minutes and then air dried at ambient temperature for 10 minutes. Next, the panels were immersed in the sealant bath described above at ambient temperature for 2 minutes with slight agitation and then air dried at ambient temperature before performance evaluation.

The corrosion performance of processed substrate was evaluated after 7 days (168 hours) of neutral salt spray testing (ASTM B117) according to the MIL-DTL-81706B specification. Painted wet adhesion was evaluated in accordance with the MIL-DTL-81706B specification referencing FED-STD-141D (Method 6301.3) for test parameters. Panels were painted with a chromate-based paint primer (MIL-PRF-23377K, Type 1, Class C2; 23377F12-GL) and/or a chromate-free paint primer (MIL-PRF-23377 REV K, Type 1, Class N Primer, Epoxy high solids; 02GN084 Deft Light Aqua Green). Tables 7-8, below, provide the results of the corrosion performance assessment for each tested sample.

TABLE 7

| Sample | Corrosion Rating on AA2024 | Adhesion Rating on AA2024 |
|---|---|---|
| 4 | No pits; no white | Negligible (little-to-no) |
| | corrosion products | paint pick-off |
| 5 | 2 pits; light amount of white | Negligible (little-to-no) |
| | corrosion products | paint pick-off |

TABLE 8

| | Sample | |
|---|---|---|
| | 6 | 7 |
| Corrosion Rating on | 1 pit; little-to-no white | 2 pits; light amount of white |
| AA2024 | corrosion | corrosion |
| Corrosion Rating on | No pits; no white corrosion | No pits; no white corrosion |
| AA6061 | | |
| Corrosion Rating on | No pits; no white corrosion | No pits; light amount of |
| AA7075 | | white corrosion |
| Adhesion Rating on | Negligible (little-to-no) paint | Negligible (little-to-no) paint |
| AA2024 (Cr primer) | pick-off | pick-off |
| Adhesion Rating on | Negligible (little-to-no) paint | Negligible (little-to-no) paint |
| AA6061 (Cr primer) | pick-off | pick-off |
| Adhesion Rating on | Negligible (little-to-no) paint | Passing (no paint pick-off) |
| AA7075 (Cr primer) | pick-off | |
| Adhesion Rating on | Passing (no paint pick-off) | Passing (no paint pick-off) |
| AA2024 (Non-Cr primer) | | |
| Adhesion Rating on | Passing (no paint pick-off) | Passing (no paint pick-off) |
| AA6061 (Non-Cr primer) | | |
| Adhesion Rating on | Passing (no paint pick-off) | Negligible (little-to-no) paint |
| AA7075 (Non-Cr primer) | | pick-off |

### Example 4—Comparative Evaluation

Pretreatment systems based on permanganate and/or cerium conversion coatings with lithium-containing sealant layers disclosed in U.S. Pub. Nos. 2016/0083849 and 2019/0316261 (both incorporated herein by reference) were screened for comparative evaluation. The best performing examples disclosed in these publications were reproduced. Panels were treated with first-stage conversion coating bath solutions containing either: (1) sodium permanganate, (2) sodium permanganate and cerium nitrate, or (3) a mixture of yttrium nitrate, cerium nitrate, cerium chloride, and hydrogen peroxide; then, treated with second-stage coating baths containing either: (1) lithium carbonate or (2) lithium carbonate and benzotriazole. The above-cited published patent application stated that AA2024-T3 panels were immersed in the conversion coating baths at room temperature for 2 (permanganate-based baths) or 5 (yttrium-based bath) minutes and after 4 days (96 hours) of neutral salt spray testing (in accordance with ASTM B117) looked substantially identical to how they appeared upon entering testing. These disclosed variations were repeated as described in the publications.

Results. The panels treated with BONDERITE® M-NT 1820 analog (without Cu) and sealed with baths containing lithium carbonate displayed a significant amount of paint pick-off after painted wet adhesion testing. All other panels showed PASSING painted wet adhesion or negligible paint pick-off. The panels treated with yttrium and cerium nitrate barrier layers and sealed with baths containing lithium carbonate exhibited substantial pitting and white corrosion products. The panels treated with permanganate barrier layers and sealed with baths containing lithium carbonate entered testing uniformly golden-to-dark brown in color. After neutral salt spray testing, these panels were largely brown/green iridescent in color with thin shiny streaks. The panels showed minimal white corrosion and pitting was preferentially within the shiny streaks. The panels treated with BONDERITE® M-NT 1820 analog (without Cu) and sealed with bath containing lithium carbonate demonstrated some pitting (˜10 pits) and a moderate amount of white corrosion products. However, the panel treated with BONDERITE® M-NT 1820 analog (without Cu) and sealed with the bath containing lithium polysilicate, GLYMO, DAMO, and 8-HQ showed minor pitting (<5pits) and very minor white corrosion products.

### Example 5—Sealant Composition and Application and Testing Thereof

To prepare a 700 g sealant immersion bath, 0.35 g (0.050%) of a lauryl polyglycol ether based phosphoric acid ester was stirred into 668.24 g of deionized water for 10 minutes. To this solution was added 10.41 g (1.49%) of lithium polysilicate, 20% and the solution was stirred for 10 minutes. Next, 10.50 g (1.5%) of Dynasylan® GLYMO (3-Glycidyloxypropyltrimethoxysilane) obtained from Evonik was added to this solution and the solution was stirred for 30 minutes to ensure complete dissolution. To this solution was added 10.50 g (1.5%) of Dynasylan® DAMO (N-2-Aminoethyl-3-aminopropyltrimethoxysilane) received from Evonik and the solution was stirred for 10 minutes (pH=10.29). Table 9 below provides a summary of the components of the sealant composition.

TABLE 9

| Component | Amount g | |
|---|---|---|
| Deionized water | 668.24 | g |
| Lauryl polyglycol ether based phosphoric acid ester | 0.35 | g |
| Lithium polysilicate, 20% | 10.41 | g |
| Dynasylan ® GLYMO | 10.50 | g |
| Dynasylan ® DAMO | 10.50 | g |

A Q-Lab AA2024-T3 aluminum panel (3″×10″×0.032″) was immersed into an aqueous alkaline degreaser bath (BONDERITE® C-AK 6849 at 20% (v/v) and 60° C.) for 15 minutes with constant agitation. The panel was then immersed into a warm tap water rinse tank for 5 minutes, then immersed into an acidic deoxidizing bath (BONDERITE® C-IC 2310 at 15% (v/v)+25% HNO₃ (v/v) and ambient temperature) for 5 minutes (etch rate of clad panel=0.1-0.4 mils/surface/hour). After deoxidation, the panel was immersed into an ambient tap water rinse tank for 2 minutes before being immersed into the “Non-Cr Conversion Coating” conversion coating containing BONDERITE® M-NT 1820 (without copper additive; 3% (v/v); pH=4.2-4.4; free fluoride=50 ppm) at ambient temperature for 10 minutes with agitation by magnetic stirring at 300 rpm. Following conversion coating, the panel was immersed into an ambient deionized water rinse tank for 2 minutes and then air dried at ambient temperature for 10 minutes. Next, the panel was immersed in the sealant bath described above at ambient temperature for 2 minutes with slight agitation and then air dried at ambient temperature before performance evaluation.

The corrosion performance of processed substrate was evaluated after 7 days (168 hours) of neutral salt spray testing (ASTM B117) according to the MIL-DTL-81706B specification. Painted wet adhesion was evaluated in accordance with the MIL-DTL-81706B specification referencing FED-STD-141D (Method 6301.3) for test parameters. Panels were painted with a chromate-based paint primer (MIL-PRF-23377K, Type 1, Class C2; 23377F12-GL) and/or a chromate-free paint primer (MIL-PRF-23377 REV K, Type 1, Class N Primer, Epoxy high solids; 02GN084 Deft Light Aqua Green). Table 10, below, provides the results of the corrosion performance assessment for each tested sample.

TABLE 10

| | Corrosion Rating | Adhesion Rating |
|---|---|---|
| Sample | on AA2024 | on AA2024 |
| 6 | No pits; little-to-no white | Negligible (little-to-no) |
| | corrosion products | paint pick-off (Cr primer) |
| 7 | No pits; no white | Passing (no paint pick-off) |
| | corrosion products | (Non-Cr primer) |

### Example 6—Sealant Composition and Application and Testing Thereof

To prepare a 700 g sealant immersion bath, 0.31 g (0.044%) of lauryl polyglycol ether based phosphoric acid ester was stirred into 671.04 g of deionized water for 10 minutes. To this solution was added 14.00 g (2.0%) of lithium polysilicate, 20% and the solution was stirred for 10 minutes. Next, 11.65 g (1.66%) of Dynasylan® GLYMO (3-Glycidyloxypropyltrimethoxysilane) received from Evonik was added to this solution and the solution was stirred for 30 minutes to ensure complete dissolution. To this solution was added 3.00 g (0.43%) of Dynasylan® DAMO (N-2-Aminoethyl-3-aminopropyltrimethoxysilane) received from Evonik and the solution was stirred for 10 minutes (pH=10.60). Table 11 below provides a summary of the components of the sealant composition.

TABLE 11

| Component | Amount (g) | |
|---|---|---|
| Deionized water | 671.04 | g |
| Lauryl polyglycol ether based phosphoric acid ester | 0.31 | g |
| Lithium polysilicate, 20% | 14.00 | g |
| Dynasylan ® GLYMO | 11.65 | g |
| Dynasylan DAMO | 3.00 | g |

A Q-Lab AA2024-T3, AA6061-T3, and AA7075-T6 aluminum panels (3″×10″×0.032″) were immersed into an aqueous alkaline degreaser bath (BONDERITE® C-AK 6849 at 20% (v/v) and 60° C.) for 15 minutes with constant agitation. The panels were then immersed into a warm tap water rinse tank for 5 minutes, then immersed into an acidic deoxidizing bath (BONDERITE® C-IC 2310 at 15% (v/v)+25% HNO₃ (v/v) and ambient temperature) for 5 minutes (etch rate of clad panel=0.1-0.4 mils/surface/hour). After deoxidation, the panels were immersed into an ambient tap water rinse tank for 2 minutes before being immersed into the “Non-Cr Conversion Coating” conversion coating containing BONDERITE® M-NT 1820 (without copper additive; 3% (v/v); pH=4.2-4.4; free fluoride=50 ppm) at ambient temperature for 10 minutes with agitation by magnetic stirring at 300 rpm. Following conversion coating, the panels were immersed into an ambient deionized water rinse tank for 2 minutes and then air dried at ambient temperature for 10 minutes. Next, the panels were immersed in the sealant bath described above at ambient temperature for 2 minutes with slight agitation and then air dried at ambient temperature before performance evaluation.

The corrosion performance of processed substrate was evaluated after 7 days (168 hours) of neutral salt spray testing (ASTM B117) according to the MIL-DTL-81706B specification. Painted wet adhesion was evaluated in accordance with the MIL-DTL-81706B specification referencing FED-STD-141D (Method 6301.3) for test parameters. Panels were painted with a chromate-based paint primer (MIL-PRF-23377K, Type 1, Class C2; 23377F12-GL) and/or a chromate-free paint primer (MIL-PRF-23377 REV K, Type 1, Class N Primer, Epoxy high solids; 02GN084 Deft Light Aqua Green). Table 12, below, provides the results of the corrosion performance assessment for each tested sample.

TABLE 12

| | Sample | |
|---|---|---|
| | 8 | 9 |
| Corrosion Rating on AA2024 | No pits; little-to-no white corrosion | No pits; little-to-no |
| | | white corrosion |
| Corrosion Rating on AA6061 | No pits; no white corrosion | |
| Corrosion Rating on AA7075 | No pits; little-to-no white corrosion | |
| Adhesion Rating on AA2024 | Negligible (little-to-no) paint pick- | |
| (Cr primer) | off | |
| Adhesion Rating on AA6061 | Passing (no paint pick-off) | |
| (Cr primer) | | |
| Adhesion Rating on AA7075 | Negligible (little-to-no) paint pick- | |
| (Cr primer) | off | |
| Adhesion Rating on AA2024 | Passing (no paint pick-off) | Passing (no paint |
| (Non-Cr primer) | | pick-off) |
| Adhesion Rating on AA6061 | Passing (no paint pick-off) | |
| (Non-Cr primer) | | |
| Adhesion Rating on AA7075 | Passing (no paint pick-off) | |
| (Non-Cr primer) | | |

### Example 7—Glow Discharge Optical Emission Spectrometry (GD-OES)

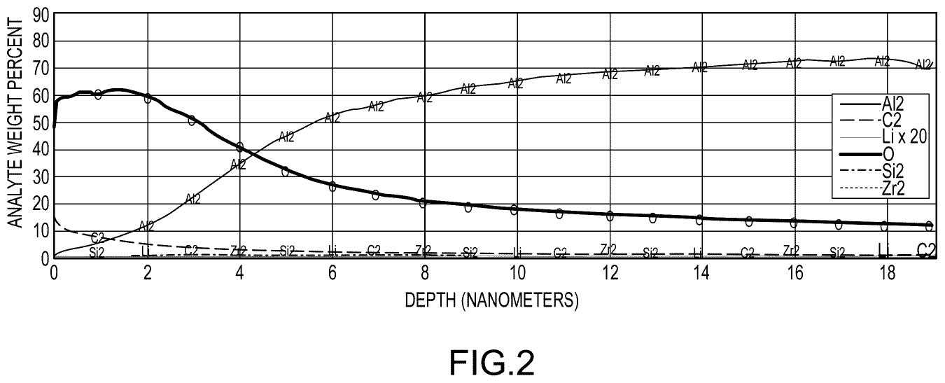

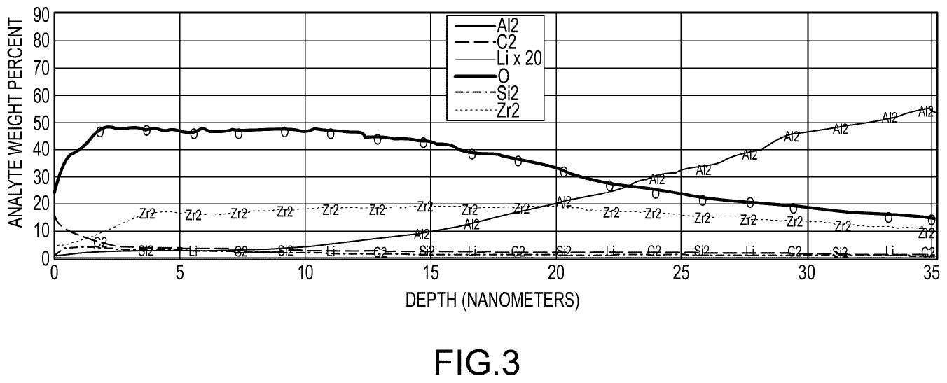

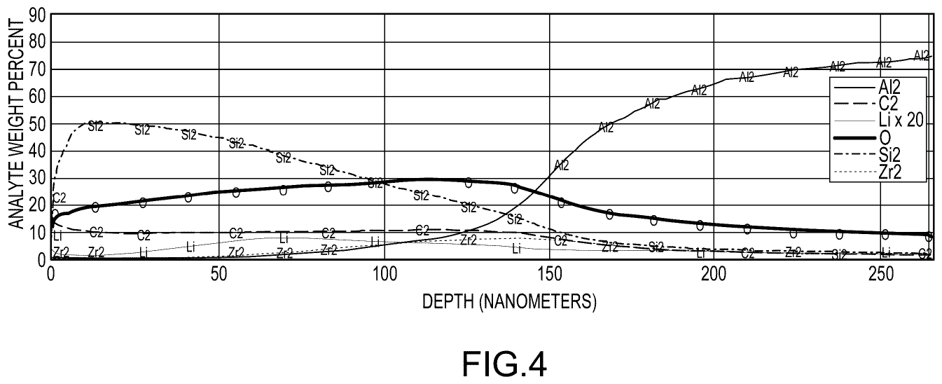

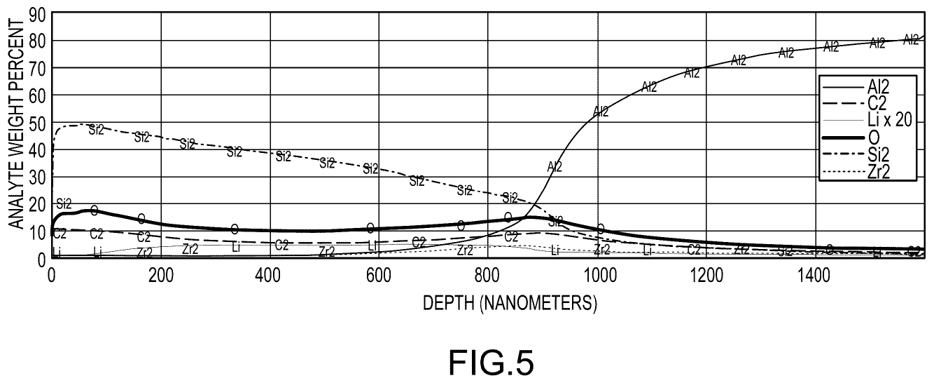

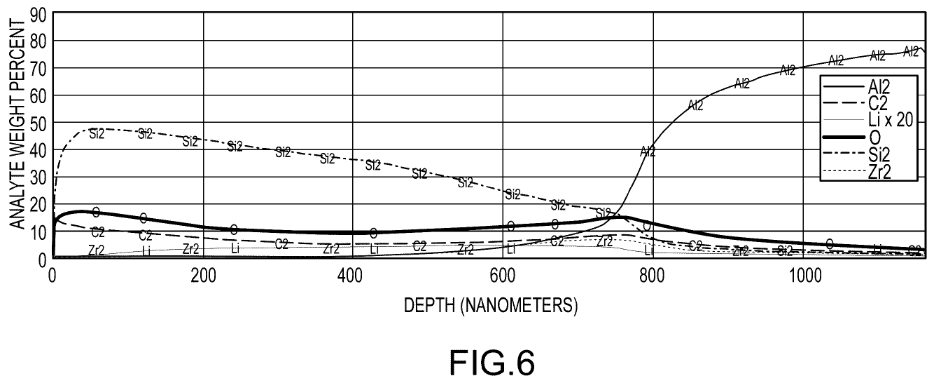

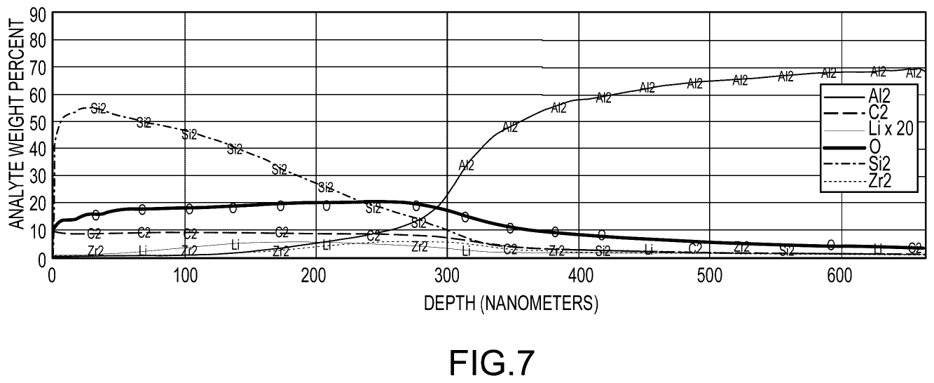

GD-OES spectra were acquired for: (1) cleaned and deoxidized AA2024 aluminum alloy (FIG. 2); (2) the cleaned and deoxidized AA2024 aluminum alloy processed through “Non-Cr Conversion Coating” conversion coating containing BONDERITE® M-NT 1820 (without copper additive; 3% (v/v); pH=4.2-4.4; free fluoride=50 ppm) at ambient temperature for 10 minutes with agitation (FIG. 3); and, the conversion coated samples respectively immersed in a sealant baths according to Example 3 (FIG. 4), Example 3 (FIG. 5), Example 5 (FIG. 6), or Example 6 (FIG. 7) at ambient temperature for 2 minutes with agitation.

Three burns were taken on each of the samples and the most representative GD-OES spectra were collected. Spectra were plotted showing aluminum (A12), carbon (C2), lithium (Li x 20), oxygen (O), silicon (Si2) and zirconium (Zr2). GD-OES spectra acquired from replicate burns on the single samples showed consistent and reproducible behavior in layer thicknesses and elemental distributions. The minor shifts in oxide thickness and slight differences in surface soils are typical of the variability seen across replicate burns.

The skilled artisan will understand that the foregoing Examples are merely embodiments illustrating the inventions components and performance. They are in no way intended to limit the invention to the exemplary embodiments.

What is claimed:

1. A sealant composition for conferring corrosion resistance on a metal surface comprising:
a. lithium polysilicate;
b. a corrosion inhibitor; and,
c. an adhesion promoter; and
d. water;
wherein the sealant composition contains substantially no chromium (VI).

2. The sealant composition according to claim 1, wherein the lithium polysilicate is present in an amount of about 1-3 wt. %, based on the total weight of the composition.

3. The sealant composition according to claim 2, wherein the lithium polysilicate is present in an amount of about 1.45-2.25 wt. %, based on the total weight of the composition.

4. The sealant composition according to claim 1, wherein the corrosion inhibitor comprises one or more of a quinoline, an organic phosphate ester, an azolic functional molecule, or any combination thereof.

5. The sealant composition according to claim 4, wherein the corrosion inhibitor comprises 8-hydroxyquinoline, an organic phosphate ester, salicylaldoxime, quinaldic acid, 1H-benzotriazole, tolyltriazole, methyl-1-H-benzotriazole, 2-mercaptobenzothiazole, 2-mercaptobenzoxazole, 5-amino-1,3,4-thiadiazole-2-thiol, L-cysteine, 5-aminotetrazole, 2-aminothiazole, or any combination thereof.

6. The sealant composition according to claim 4, wherein the corrosion inhibitor comprises 8-hydroxyquinoline.

7. The sealant composition according to claim 4, wherein the corrosion inhibitor comprises a C8-C16-alkyl polyglycol ether.

8. The sealant composition according to claim 4, wherein the corrosion inhibitor comprises a lauryl polyglycol ether based phosphoric acid ester.

9. The sealant composition according to claim 1, wherein the corrosion inhibitor is present in an amount of about 0.005 wt. %, based on the total weight of the composition, up to the solubility limit of the corrosion inhibitor in the sealant composition.

10. The sealant composition according to claim 1, wherein the composition is alkaline.

11. The sealant composition according to claim 1, wherein the adhesion promoter comprises an organofunctional alkoxysilane compound.

12. The sealant composition according to claim 1, wherein the adhesion promoter includes alkoxy functional groups.

13. The sealant composition according to claim 12, wherein the adhesion promoter includes organofunctional groups comprising epoxy, epoxyalkyl, epoxyalkoxy, amino, aminoalkyl, or aminoalkylamino groups, or any combination thereof.

14. The sealant composition according to claim 11, wherein the adhesion promoter comprises 3-glycidyloxypropyltrimethoxysilane, N-2-aminoethyl-3-aminopropyltrimethoxysilane, or both.

15. The sealant composition according to claim 4, wherein the adhesion promotor is present in an amount of about 0.5-5 wt. %, based on the total weight of the composition.

16. The sealant composition according to claim 1, further comprising a surfactant.

17. The sealant composition according to claim 1, wherein the sealant composition does not include any source of a metal, other than the lithium polysilicate.

18. A method for protecting a metal surface against corrosion comprising contacting a conversion coated metal surface with a sealant composition according to claim 1.

19. The method according to claim 18, wherein the conversion coated metal surface is contacted with the sealant composition, optionally by immersion, under ambient temperature conditions.

20. The method according to claim 18, wherein the metal surface comprises aluminum or an aluminum alloy.

21. The method according to claim 18, further comprising contacting the metal surface with a conversion coating composition prior to the step of contacting the metal surface with the sealant composition, wherein the conversion coating composition does not contain any source of chromium.

22. The method according to claim 21, wherein the conversion coating composition comprises a Group IVB metal, optionally comprising oxides of the Group IVB metal.

23. The method according to claim 22, wherein the conversion coating comprises Zr, Ti, or both.

24. The method according to claim 18, further comprising a step of deoxidizing the metal surface prior to contacting the metal surface with a conversion coating composition.

25. The method according to claim 24, further comprising a step of degreasing the metal surface prior to deoxidizing the metal surface, and prior to contacting the metal surface with a conversion coating composition.

26. A metal component comprising a metal surface, optionally comprising aluminum or an aluminum alloy, that has been contacted with a sealant composition according to claim 1.

27. An article comprising a metal component according to claim 26.

28. An article of manufacture comprising:
a. a metal surface having deposited thereon a conversion coating comprising a Group IVB metal, and
b. a sealant layer, comprising Li, Si, C and O, wherein the sealant layer is dried in place on the conversion coating.

29. An article of manufacture comprising a metal surface having deposited thereon a sealant layer in which lithium is distributed in an amount of about 2-7 mg/m², as measured by glow discharge optical emission spectrometry (GD-OES).
